(19) United States
(12) Patent Application Publication
(10) Pub. No.: US 2011/0080704 A1
(43) Pub. Date: Apr. 7, 2011

(54) "News new" is an electronic news medium, to be used instead of newspapers

(76) Inventor: Jerry Forrester, Brooklyn, NY (US)

(21) Appl. No.: 12/587,361

(22) Filed: Oct. 6, 2009

(51) Int. Cl. G06F 1/16; G06F 3/048

(52) U.S. Cl. 361/679.28; 715/764

(57) ABSTRACT

A reusable portable handheld electronic information medium comprises flexible laminated materials, which can be repeatedly bent and straightened out without fracturing. A Crease 70 bordering a left side 10 and a right side 20; a Base 80 is positioned between a front side 30 and a back side 40, and base 80A is positioned between a front side 50 and a back side 60. Side 30 having front displaying elements 32, cooperating with communicating element 34, a memory controller 11, and a transmittal cover 25. Side 40 having back displaying elements 42, cooperating with communicating element 44, memory controller 11, and transmittal cover 26. Side 50 having front displaying elements 52, cooperating with communicating element 54, memory controller 21, and transmittal cover 26. Side 60 having back displaying elements 62, cooperating with communicating element 64, memory controller 11, and transmittal cover 25. In addition battery power source (not shown) having access plug 72 for charger to replenish battery, and information access plug 82 for replacing information. Page selectors 14 and 16 used to select a desired page to be displayed. Being foldable and reusable, with functions to enable updating and backdating of news from outside source and also rechargeable option enabling the present invention to be used for displaying daily and past news without having to discard of the electronic news medium and replacing it with a new one, each time a person needs to read the news.

### BACKGROUND OF THE INVENTION

The present invention relates to a handheld information medium in a soft foldable form. A typical handheld electronic device is sold with varying shapes. Pat. No. U.S. D460,4935 application Ser. No. 29/130,854 inventor Griffin Et Al, shows a solid ornamental design. Pat. No. Des 390, 211 application No. 65545 shows ornamental design for combined computer and touch pad with a solid form. Pat. No. U.S. D449,606 S application Ser. No. 29/132,621 is a portable electronic book in a solid form field of search which includes D14/315,342; D12/345,322; D19/265,960; D18/12,7; 345/104, 156, 168, 169, 173,87,901-905; 361/680-686; 400/486,489, are not easily handled like newspapers. The present invention is foldable, re-usable, re-storable and up-dateable with flexibility for handling like paper.

### BRIEF SUMMARY OF THE INVENTION

Accordingly, it is an advantage of the present invention that a foldable, re-useable and resilient synthetic laminated element of material is adapted to display, erase and restore information, is provided.

It is another advantage of the present invention that a handheld news medium is provided that may be adapted for re-storability in various places like street corners, new stands, malls, schools, libraries, homes among other places.

In the embodiment of the present invention a flexible synthetic element of durable material is adapted to store and display information in a clear and readable form.

Accordingly, it's an objective of the present invention to provide a re-usable, flexible and portable handheld news medium, which can be repeatedly bent and straightened out without fracturing.

Other aspects and advantages of the invention will become apparent from the following description taken in conjunction with the accompanying drawings, illustrating by way of example the principles of the invention.

It is a further object of the invention to provide an erasable and re-storable news medium for storing and displaying mass information.

Accordingly besides the objects and advantages of the electronic reading books and other handheld electronic device; none provide advantages comparable to the present invention.

Several other objects and advantages of the present invention are:
(a) To provide a portable handheld electronic device that is flexible and transmittable;
(b) To provide a re-usable electronic medium to use in place of newspapers and other information providers;
(c) To provide information in a clear and orderly fashion on flexible synthetic sheets having displaying elements thereof, and displaying a form of a electronic news papers
(d) To provide options such as
   1. page selector, for selecting preferred page for reading.
   2. rechargeable power source with access to outside power source.
   3. erasable memory with access to outside source for downloading of new information for storage in memory

### BRIEF DESCRIPTION OF SEVERAL VIEWS OF THE DRAWINGS

FIG. 1 is a perspective view of the present invention closed and in an upright position showing the front page similar to a newspaper front page.

FIG. 2 is a perspective view of the invention in an upright position partially open showing the inside pages illustrating pages 2 and 3, and the laminated sides.

FIG. 3 is a perspective view of the invention in an upright position open showing the outer side, illustrating the front page and the back or last page.

FIG. 4 is a similar vie as FIG. 3, showing the inside pages, illustrating pages 2 and 3.

FIG. 5 A is a perspective view of the invention open showing the outer side illustrating the front page and the back or last page, with torn off lamination to show internal makeup.

FIG. 5 AA is a perspective end view showing various combinations of laminations.

FIG. 6 is a similar view to FIG. 5, open showing the inside pages with torn off lamination to show internal makeup.

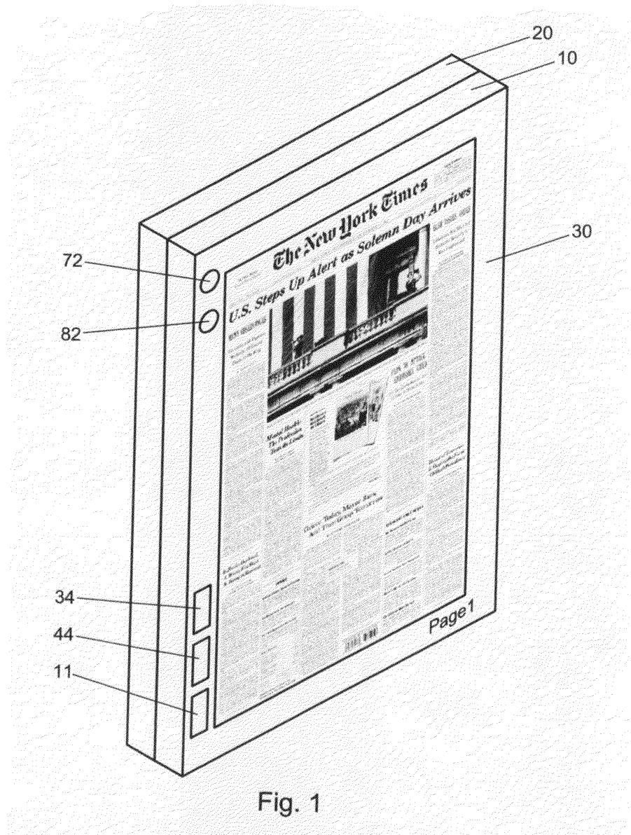

### REFERENCE NUMERALS IN DRAWINGS

LEFT SIDE 10
RIGHT SIDE 20
SIDE 10 FRONT SIDE 30
SIDE 10 BACK SIDE 40
SIDE 20 FRONT SIDE 50
SIDE 20 BACK SIDE 60
CREASE 70
LEFT BASE 80
RIGHT BASE 80A
SIDE 10 FRONTAL DISPLAYING ELEMENTS 32
SIDE 10 BACK DISPLAYING ELEMENTS 42
SIDE 10 FRONT COMMUNICATING ELEMENT 34
SIDE 10 BACK COMMUNICATING ELEMENT 44
SIDE 20 FRONT DISPLAYING ELEMENTS 52
SIDE 20 BACK DISPLAYING ELEMENTS 62
SIDE 020 FRONT COMMUNICATING ELEMENT 54
SIDE 20 BACK COMMUNICATING ELEMENT 64
POWER ACCESS PLUG 72
INFORMATION ACCESS PLUG 82
BACKWARD PAGE SELECTOR 14
FORWARD PAGE SELECTOR 16
RIGHT SIDE MEMORY CONTROLLER 21
OUTER SIDE TRANSMITTAL COVER 25
INSIDE TRANSMITTAL COVER 26

### DETAILED DESCRIPTION OF THE INVENTION

The present invention relates to a flexible and re-usable handheld medium for providing information like the newspaper industries does.

The embodiment includes an outer synthetic paper-like encasement sandwiching a flexible base having displays thereof. The flexible base having communicating elements for receiving commands from outside sources.

The embodiment further includes a turn page portion, having means for communication instruction to turn pages. A reader may press the turn page forward or backward in order to change a displayed page.

The present invention provide a substitute synthetic news paper-like medium for use in place of newspapers and having laminations adapted to store and display information, enabling newspaper readers to utilize a foldable paper-like synthetic element containing daily information usually in newspapers, and allowing for turning pages, and includes elements for communication information with outside source, whereby current information can be replaced with yesterdays, and other prior dated information may be downloaded for use.

The present invention, having a protective transmittal covering that cooperates with internal storage and displaying elements adapted to communicate with external sources.

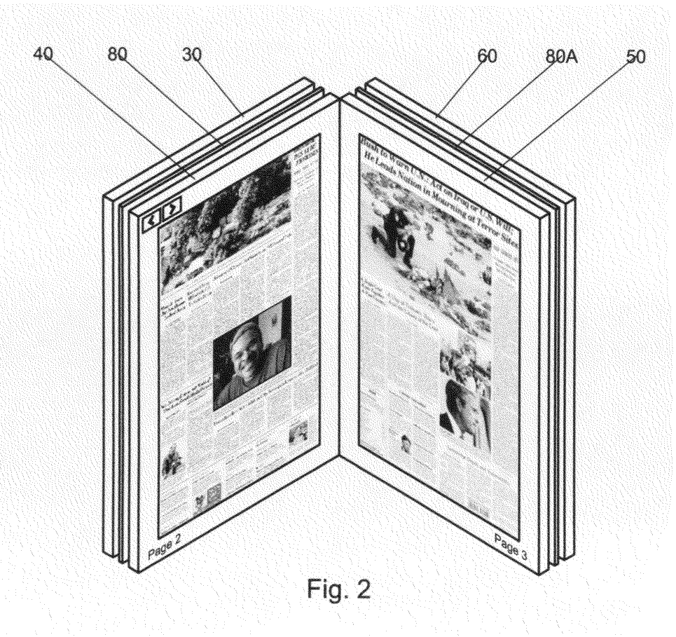

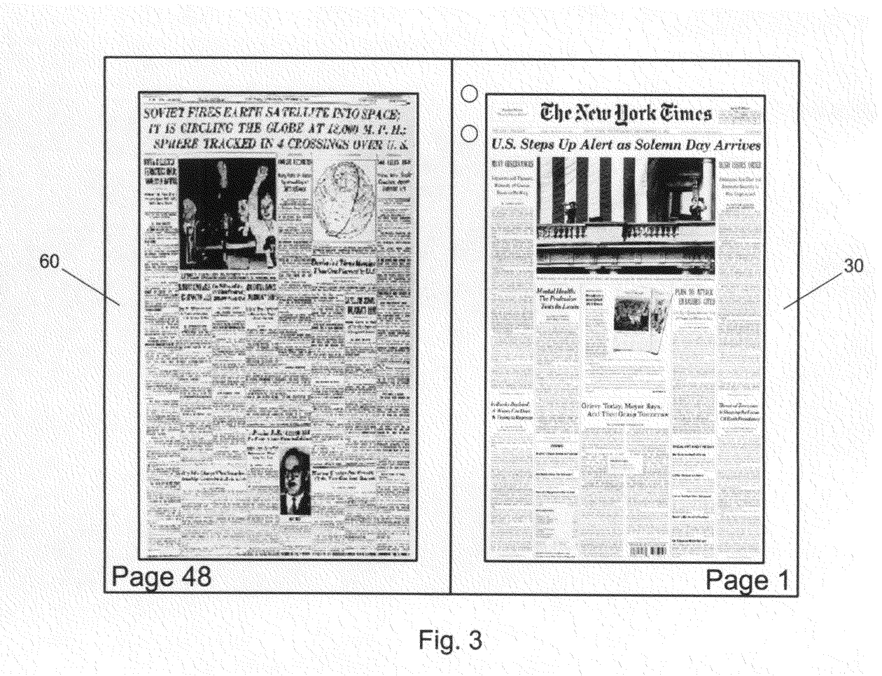

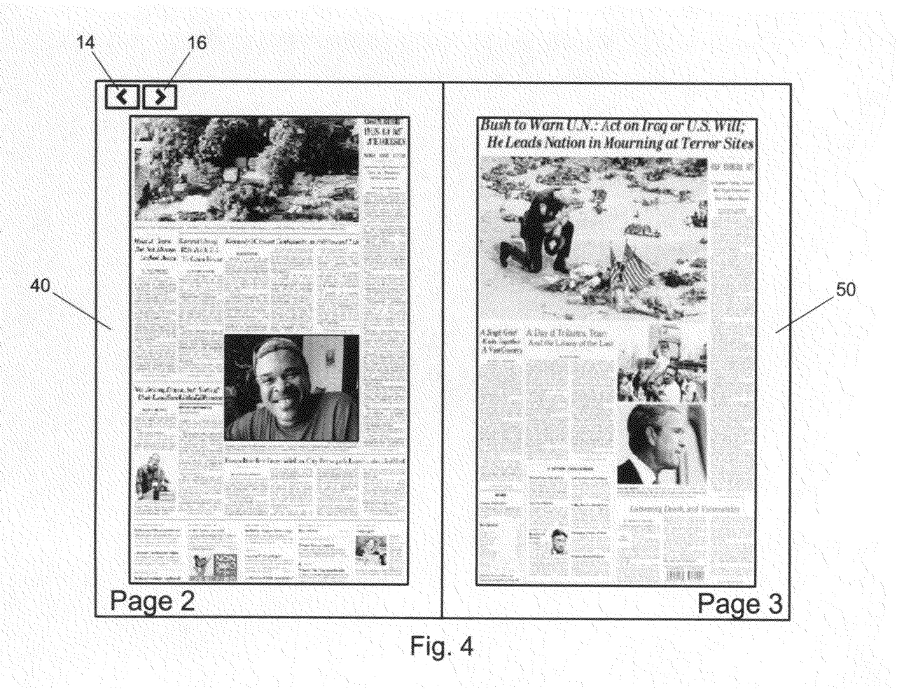

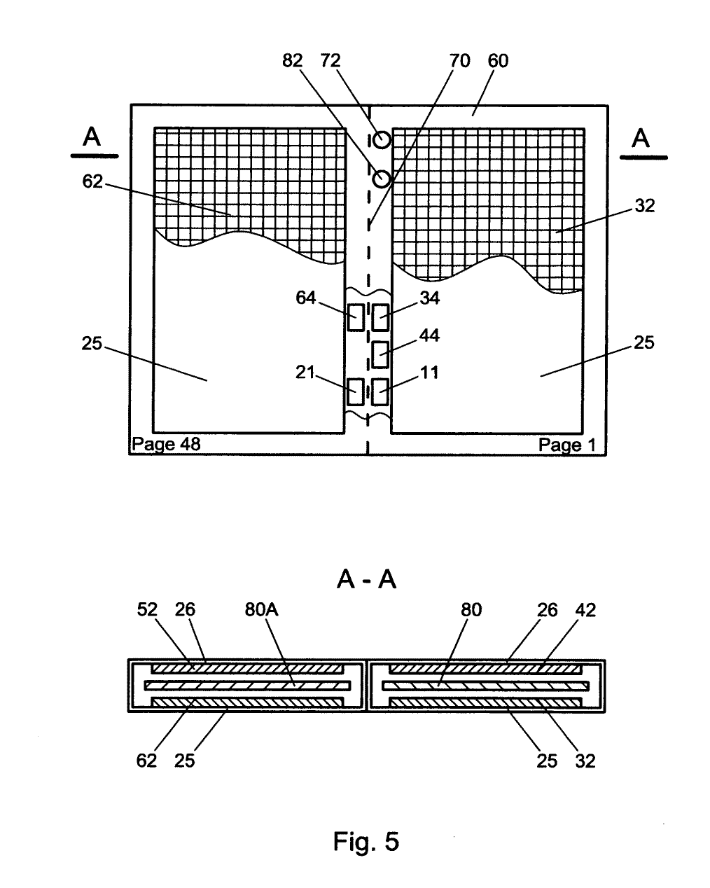

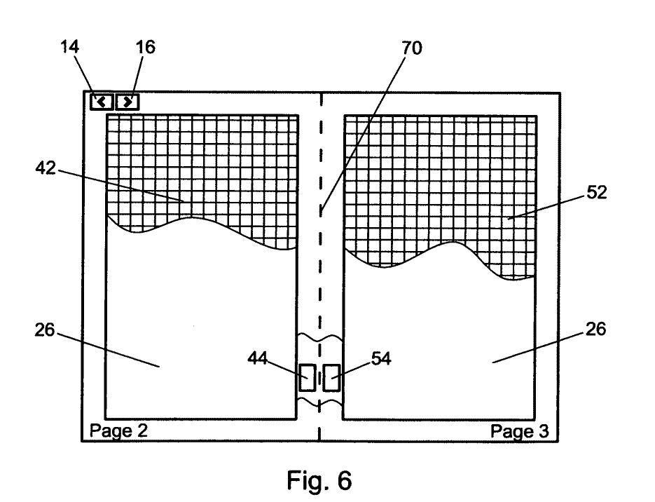

The present invention provide a flexible re-usable news medium for use instead of newspapers adapted to fold in two halves; a left half 10, and a right half 20 half 10 having a front face side 30 and back face side 40, and half 20 having a front face side 50, and a back face side 60, a foldable creased middle area 70, two base 80 A and 80 separating the elements position thereof as illustrated in the drawing of FIG. 2 and FIG. 5 A-A inner core elements not showed in the drawings are kept in a functionable position by transmittal covering 25 and 26 half 10 includes a front displaying element 32 having displaying elements thereof and a back displaying element 42 having displays thereof, element 32 is adapted to accommodate and cooperate with front communicating elements 34 and element 42 is adapted to accommodate and cooperate with back communicating elements 44 half 20 includes a front displaying element 52 having displays thereof, and a back displaying element 62 having displays thereof. Element 62 is adapted to accommodate and cooperate with communicating elements 64 and element 52 is adapted to accommodate and cooperate with communicating elements 54.

Middle area illustrate having battery access plug 72 and information access plug 82 thereof.
Half 10 includes backward page selector 14 and forward page selector 16 for changing pages.
The flexible plastic transmittal covering of the present invention include a outer covering 25 and an inside covering 26.

The half 10 front face 30 and back face 40 having separate communicating elements, a frontal 32 and a rear 42 whereby the front half 10 may display different information on face 30 front page to what is being displayed on face 40 the next page displayed.

Half 20 front face 50 displaying designated page and back face 60 having separate communicating elements, a front 52 and a back 62 for communicating independent of each other, whereby face 50 and face 60 may store and display different information.

Thus the reader will see that the flexible medium of the invention provides a reliable, lightweight, environmentally friendly and economical device that can be used by persons of almost any age.

While my above description contains much specificities these should not be construed as limitations on the scope of the invention, but rather as an exemplification of one preferred embodiment thereof, many other variations are possible.

What I claim:

1. A method of displaying stored information through flexible laminations, comprising:
(a) providing a memory which is able to store information on a display,
(b) providing displaying elements which is operatively connected to said memory for displaying said information
(c) providing a memory controller which will:
(1) direct said information to pre-determined location on said displaying elements for displaying,
(2) causing all information stored in said memory to be transferable to a designated location for displaying, so that said information will be stored in said memory at said location to be displayed on said displaying elements, whereby said displaying elements will display said information at said designated location, and whereby a reader can select said information by selecting a page within existing body of information for displaying in a fashion comparable to newspapers,
(d) a page selector which is used for selecting information by selecting said page that said information is stored for,
(e) providing a information transmission means which a computer can transfer information to be stored for displaying in a still fashion (or form)
(f) providing a information editing means wherein said information stored for displaying can be changed to other dated information, such as past or present news that may be made available from the appropriate industry,
(g) providing a power source to allow supply of said power to enable said information to be displayed in a clear fashion,

2. According to claim 1 wherein said laminations comprises a resilient, synthetic, soft, and flexible plastic-like covering, said covering encases said displaying elements, said memory, said memory controller, said power source, said page selector, said information transmission means and said information editing means in a functionable form whereby said information stored in said memory may be selectively displayed and may resemble newspaper pages,

3. according to claim 1 wherein said power source comprises a rechargeable power source with communicating means to outside power source,

4. A reusable handheld flexible information storage and display medium comprising:
(a) a body having bending and folding capability for enabling said body to be bent and folded for easy handling,
(b) a memory mounted in said body for storing said information
(c) a polarity of display means mounted in said body and having insignias for identification of different sections
(d) a selector having forward and backward selecting means for selecting said information to be displayed on said display means according to a assigned page identifier,
(e) a memory controller for sectionalizing said information to be stored in said memory for displaying on said display means,
(f) a access means to enable passage of said information to and from said medium and a outside source, whereby a user can update and go back to a previous dated information for displaying on said display means, and whereby said selector enables controlling selective sections in an orderly fashion to be displayed on said display means,
a rechargeable battery means with access to outside power source,

5) According to claim 4 wherein said medium comprising said body having the capability to be folded and unfolded wherein said body comprises a durable, flexible and transmittable synthetic material whereby said medium maybe used instead of newspapers,

6) According to claim 4 wherein the medium having said memory mounted in said body is sealable secured and adapted to said flexible body and is capable of said information transmission to said display means and outside sources, whereby said medium can display selective dated information like current and past news on newspapers,

7) According to claim 4 wherein said display means are positioned for displaying said information in a clear form and is adapted to function in said flexible body and is in communication with said memory, whereby said information from said memory can be displayed on said display means,

8) According to claim 4 wherein said selector is adapted to function as a page changer for displaying a desired page with said information to be displayed whereby a human may view any page with information stored for display,

9) According to claim 4 wherein said memory controller is capable of directing said information to be positioned for display at specified locations for specified display means,

10) According to claim 4 wherein said battery means is adapted to function inside said flexible body and is capable of providing power to the various elements of said medium,

11) According to claim 4 wherein said access means includes access plugs for transferring information from outside source to said medium, whereby said information may be displayed on said display means,
A portable, flexible and foldable handheld apparatus

12. for storing and displaying information on a newspaper-like medium thereof comprising:
(a) a memory which is able to store information at an adjacent insignia in said memory,
(b) a information input means which a externals information source can use to input information in said memory at said adjacent insignia,
(c) a polarity of displaying elements which is operatively connected to said memory for displaying said information stored in said memory at said adjacent insignia,
(d) a selector means which a user can manipulate to select sections from said adjacent insignias to be displayed in said sections on said displaying elements,
(e) a flexible covering for keeping in functional positions the various elements of said apparatus
(f) a memory controller which will:
(1) direct all information which said outside source inputed via to a location in said memory, beginning at an insignia corresponding to the location between said adjacent information for displaying on said displaying elements,
(2) to cause said information which are stored in said memory at insignias subsequent to said location in said memory to be transposed to subsequent locations in said memory so that said information will be stored in said memory for said locations between all of said subsequent insignias, whereby said displaying elements will display said information within said insignias at said locations, and whereby a user can select said insignias sections to be displayed in a orderly and clean fashion without having to manually turn a page for selecting said information between said insignias to be displayed on said displaying elements,
